(19) United States
(12) Patent Application Publication
(10) Pub. No.: US 2007/0028125 A1
(43) Pub. Date: Feb. 1, 2007

(54) Method for controlling operating frequency of integrated circuit

(76) Inventor: Masanori Kitanaka, Osaka (JP)

Correspondence Address: MCDERMOTT WILL & EMERY LLP, 600 13TH STREET, N.W., WASHINGTON, DC, 20005-3096, US

(21) Appl. No.: 11/491,030

(22) Filed: Jul. 24, 2006

(30) Foreign Application Priority Data
Jul. 28, 2005 (JP) 2005-219327

(51) Int. Cl. G06F 1/00

(52) U.S. Cl. 713/300

(57) ABSTRACT

A method is provided for controlling an operating frequency of an integrated circuit when operating modes with different operating frequencies are changed. The method comprises the step of changing the operating frequency of the integrated circuit to an operating frequency of an operating mode after changing, in a stepwise manner.

### BACKGROUND OF THE INVENTION

The present invention relates to an integrated circuit, and more particularly, to a technique for reducing a steep change in a power supply current when an operating frequency of an integrated circuit is changed.

There is a known technique for suppressing a variation in a power supply voltage during a stable operation of an integrated circuit by regulating a phase of a clock which is supplied to an internal circuit of the integrated circuit (see, for example, JP No. 2004-88638 A).

Thus, the power supply voltage can be stabilized by regulating the phase of the clock which is supplied. However, even with this technique, a power supply current varies when operating modes of an integrated circuit are changed: from a stop state to an operating state; the operating state to the stop state; an operating mode with small power consumption to an operating mode with large power consumption; or the operating mode with large power consumption to the operating mode with small power consumption, resulting in occurrence of a spike in the power supply voltage. In other words, when operating modes are changed, a variation in the power supply voltage cannot be suppressed.

### SUMMARY OF THE INVENTION

An object of the present invention is to reduce spikes which occur in a power supply voltage when operating modes of an integrated circuit are changed, to stabilize the power supply voltage.

Specifically, the present invention provides a method for controlling an operating frequency of an integrated circuit when operating modes with different operating frequencies are changed, comprising the step of changing the operating frequency of the integrated circuit to an operating frequency of an operating mode after changing, in a stepwise manner.

Thereby, the operating frequency of the integrated circuit is changed in a stepwise manner, thereby making it possible to suppress a variation in a power supply current when operating modes are changed. Therefore, spikes occurring in the power supply voltage can be reduced, thereby making it possible to stabilize the power supply voltage.

In the integrated circuit operating frequency controlling method, preferably, when an operating frequency at the time of start of an operation of the integrated circuit or in the operating mode after changing is higher than an operating frequency of an operating mode before changing, the operating frequency of the integrated circuit is increased in a stepwise manner.

In the integrated circuit operating frequency controlling method, preferably, when an operating frequency at the time of end of an operation of the integrated circuit or in the operating mode after changing is lower than an operating frequency of an operating mode before changing, the operating frequency of the integrated circuit is decreased in a stepwise manner.

In the integrated circuit operating frequency controlling method, preferably, the operating frequency of the integrated circuit is changed by a clock supply source changing a frequency of a clock supplied to the integrated circuit.

In the integrated circuit operating frequency controlling method, preferably, the operating frequency of the integrated circuit is changed by a frequency modulating circuit supplied with a clock from a clock supply source, changing a frequency of a clock supplied to the integrated circuit.

In the integrated circuit operating frequency controlling method, preferably, the frequency modulating circuit is mounted on the same mount board as that on which the integrated circuit is provided.

In the integrated circuit operating frequency controlling method, preferably, the integrated circuit comprises a frequency modulating circuit and an internal circuit, and an operating frequency of the internal circuit is changed by the frequency modulating circuit supplied with a clock from a clock supply source, changing a frequency of a clock supplied to the integrated circuit.

In the integrated circuit operating frequency controlling method, preferably, the integrated circuit further comprises a control signal generating circuit for controlling timing with which the frequency modulating circuit changes the frequency of the clock supplied to the internal circuit.

In the integrated circuit operating frequency controlling method, preferably, the number of steps of the operating frequency and an operating frequency at each of the steps are set so that a variation in a power supply voltage supplied to the integrated circuit remains within a predetermined range.

In the integrated circuit operating frequency controlling method, preferably, when the integrated circuit is inspected, a non-defective product/defective product determination is not performed with respect to the integrated circuit before the operating frequency of the integrated circuit is changed to the operating frequency of the operating mode after changing.

Thereby, in the case of inspection, when a non-defective product/defective product determination cannot be correctly performed, the determination is disabled, so that erroneous determination can be avoided.

As described above, according to the present invention, it is possible to reduce spikes which occur in a power supply voltage when operating modes of an integrated circuit are changed, to stabilize a power supply voltage. The amount of undershoot of the power supply voltage can be reduced, and an undershoot generation period can be reduced. Therefore, a malfunction can be prevented from occurring in an operation of the integrated circuit, and a time required to wait for recovery of the power supply voltage can be reduced. In addition, the amount of overshoot of the power supply voltage can be reduced. Therefore, it is possible to achieve prevention of an erroneous operation of an integrated circuit, reduction of a time required to change operations, and prevention of breakdown due to overvoltage when operating modes are changed during inspection or actual use.

### BRIEF DESCRIPTION OF THE DRAWINGS

FIG. 1 is a block diagram illustrating a circuit according to an embodiment of the present invention.

FIGS. 2A to 2C are graphs illustrating an operation of an LSI when operating modes are changed. FIG. 2A indicates a current (power supply current) supplied to the LSI, FIG. 2B indicates a power supply voltage supplied to the LSI, and FIG. 2C indicates a clock frequency of an internal circuit of the LSI.

FIG. 3 is a block diagram illustrating a variation of the circuit of FIG. 1.

FIG. 4 is a block diagram illustrating another variation of the circuit of FIG. 1.

FIG. 5 is a block diagram illustrating still another variation of the circuit of FIG. 1.

FIG. 6 is a block diagram illustrating an exemplary configuration of a frequency modulating circuit of FIGS. 3 to 5.

FIG. 7 is a diagram for explaining insertion of a dummy cycle during inspection.

### DETAILED DESCRIPTION OF THE PREFFERED EMBODYMENTS

Hereinafter, embodiments of the present invention will be described with reference to the accompanying drawings.

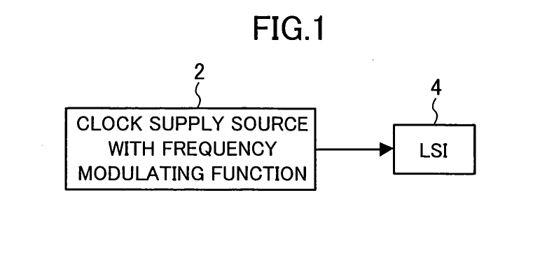

FIG. 1 is a block diagram illustrating a circuit according to an embodiment of the present invention. The circuit of FIG. 1 comprises a clock supply source 2 which has a frequency modulating function, and an integrated circuit (hereinafter referred to as an LSI) 4. The LSI 4 is mounted on a mount board, such as a printed circuit board or the like.

The LSI 4 is connected to a power supply circuit (not shown), and a voltage E0 is applied from the power supply circuit to the LSI 4 in a normal state. Hereinafter, currents other than one which the power supply circuit supplies to the LSI 4 are not taken into consideration. Under the assumption, a current supplied to the LSI 4 is equal to a power supply current i supplied from the power supply circuit.

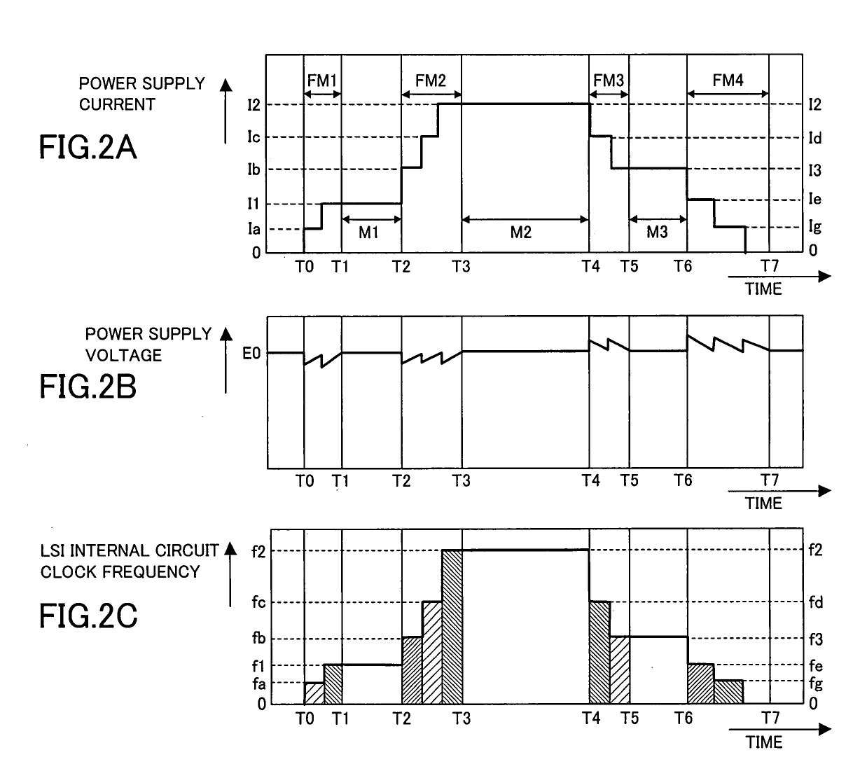

FIGS. 2A to 2C are graphs illustrating an operation of the LSI 4 when operating modes are changed. FIG. 2A indicates a current (power supply current) supplied to the LSI 4, FIG. 2B indicates a power supply voltage supplied to the LSI 4, and FIG. 2C indicates a clock frequency of an internal circuit of the LSI 4.

As illustrated in FIG. 2C, the LSI 4 has operating frequencies (clock frequencies of the internal circuit of the LSI 4) f1, f2, and f3 in operating modes M1, M2, and M3, respectively. A stop state is assumed to be one of the operating modes of the LSI 4. Power supply lines on the mount board on which the LSI 4 is provided and in the LSI 4 have an inductance L, and therefore, when the power supply current i supplied by the power supply circuit changes, a spike voltage ΔV=L×di/dt occurs, the power supply voltage undershoots or overshoots as illustrated in FIG. 2B.

Firstly, when the operating mode of the LSI 4 is changed from the stop state to the operating mode M1, the clock supply source 2 increases the operating frequency of the LSI 4 to the operating frequency f1 of the operating mode M1 in a stepwise manner (a frequency modulation period FM1) to cause the LSI 4 to operate at the operating frequency f1 (the operating mode M1). Specifically, the clock supply source 2 increases the frequency of a clock supplied to the LSI 4 to a frequency fa at time T0, and thereafter, further to the frequency f1 (see FIG. 2C).

The current supplied to the LSI 4 increases to a current Ia at time T0, and thereafter, when the clock frequency becomes f1, further increases to a current I1 (see FIG. 2A). The power supply voltage value of the LSI 4 once decreases at time T0, and thereafter, increases, and when the clock frequency becomes f1, decreases again, and thereafter, increases, and becomes substantially the voltage E0 at time T1 (see FIG. 2B).

If the clock supply source 2 suddenly starts the supply of a clock having the frequency f1 without via the frequency fa, the power supply current i instantaneously changes from 0 to I1, so that the power supply voltage largely undershoots. To avoid this, the clock supply source 2 increases the frequency of the clock supplied to the LSI 4 in a stepwise manner during the frequency modulation period FM1. As a result, a current variation per unit time (di/dt) decreases, whereby the distribution of spikes occurring in the power supply voltage can be caused to be sparse on a time axis. Therefore, the magnitude of the undershoot of the power supply voltage can be suppressed to achieve stabilization of the power supply voltage.

When the operating mode of the LSI 4 is changed from the operating mode M1 with a low operating frequency and small current consumption to the operating mode M2 with a high operating frequency and large current consumption, the clock supply source 2 increases the operating frequency of the LSI 4 to the operating frequency f2 of the operating mode M2 in a stepwise manner (a frequency modulation period FM2) to cause the LSI 4 to operate at the operating frequency f2 (the operating mode M2). Specifically, the clock supply source 2 increases the frequency of the clock supplied to the LSI 4 to a frequency fb at time T2, and thereafter, to a frequency fc, and still thereafter, to the frequency f2 (see FIG. 2C).

The current supplied to the LSI 4 increases to a current Ib at time T2, and thereafter, to currents Ic and I2 (see FIG. 2A). Every time the clock frequency increases, the power supply voltage value of the LSI 4 once decreases, and thereafter, increases. At time T3, the power supply voltage value of the LSI 4 becomes substantially the voltage E0 (see FIG. 2B).

When the operating mode of the LSI 4 is changed from the operating mode M2 with a high operating frequency and large current consumption to the operating mode M3 with a low operating frequency and small current consumption, the clock supply source 2 decreases the operating frequency of the LSI 4 to the operating frequency f3 of the operating mode M3 in a stepwise manner (a frequency modulation period FM3) to cause the LSI 4 to operate at the operating frequency f3 (the operating mode M3). Specifically, the clock supply source 2 decreases the frequency of the clock supplied to the LSI 4 to a frequency fd at time T4, and thereafter, to the frequency f3 (see FIG. 2C).

The current supplied to the LSI 4 decreases to a current Id at time T4, and thereafter, to a current I3 (see FIG. 2A). Every time the clock frequency decreases, the power supply voltage value of the LSI 4 once increases, and thereafter, decreases. At time T5, the power supply voltage value of the LSI 4 becomes substantially the voltage E0 (see FIG. 2B).

If the clock supply source 2 suddenly changes the clock frequency from the frequency f2 to the frequency f3 without via the frequency fd, the power supply current i instantaneously changes from I2 to I3, so that the power supply voltage largely overshoot. To avoid this, the clock supply source 2 decreases the frequency of the clock supplied to the LSI 4 in a stepwise manner during the frequency modulation period FM3. As a result, a current variation per unit time (di/dt) decreases, whereby the distribution of spikes occurring in the power supply voltage can be caused to be sparse on a time axis. Therefore, the magnitude of the overshoot of the power supply voltage can be suppressed to achieve stabilization of the power supply voltage.

Further, when the operating mode of the LSI 4 is changed from the operating mode M3 to the stop state, the clock supply source 2 decreases the operating frequency of the LSI 4 to zero in a stepwise manner (a frequency modulation period FM4) to cause the LSI 4 to be in the stop state. Specifically, the clock supply source 2 causes the frequency of the clock supplied to the LSI 4 to be once a frequency fe at time T6, and thereafter, decrease to a frequency fg, and still thereafter, stops the supply of the clock (see FIG. 2C).

The current supplied to the LSI 4 decreases to a current Ie at time T6, and thereafter, to currents Ig and 0 (see FIG. 2A). Every time the clock frequency decreases, the power supply voltage value of the LSI 4 once increases, and thereafter, decreases. At time T7, the power supply voltage value of the LSI 4 becomes substantially the voltage E0 (see FIG. 2B).

Here, the number of steps of the operating frequency when the operating frequency of the LSI 4 is changed in a stepwise manner (clock modulation step number) is associated with the magnitude of a change in the power supply current i due to changes in the operating mode of the LSI 4. For example, in the case of FIGS. 2A to 2C, when changes in the power supply current i due to changes in the operating mode of the LSI 4 are compared, (I1−I0)<(I2−I1). Therefore, the clock modulation step number is two steps (f0→fa→f1) at the time of starting an operation, and is three steps (f1→fb→fc→f2) when the operating mode M1 is changed to the operating mode M2.

The number of steps of the operating frequency when the operating frequency of the LSI 4 is changed in a stepwise manner and the operating frequency at each step are set so that a variation in the power supply voltage supplied to the LSI 4 remains within a predetermined range.

Note that the number of steps of the operating frequency when the operating frequency of the LSI 4 is changed in a stepwise manner, and the frequency variation may be different from those described above, as long as a variation in the power supply voltage supplied to the LSI 4 remains within a range which guarantees the operation of the LSI 4.

Although there are three operating modes, i.e., the operating mode M1, the operating mode M2, and the operating mode M3 in FIGS. 2A to 2C, the number of operating modes may be different from three.

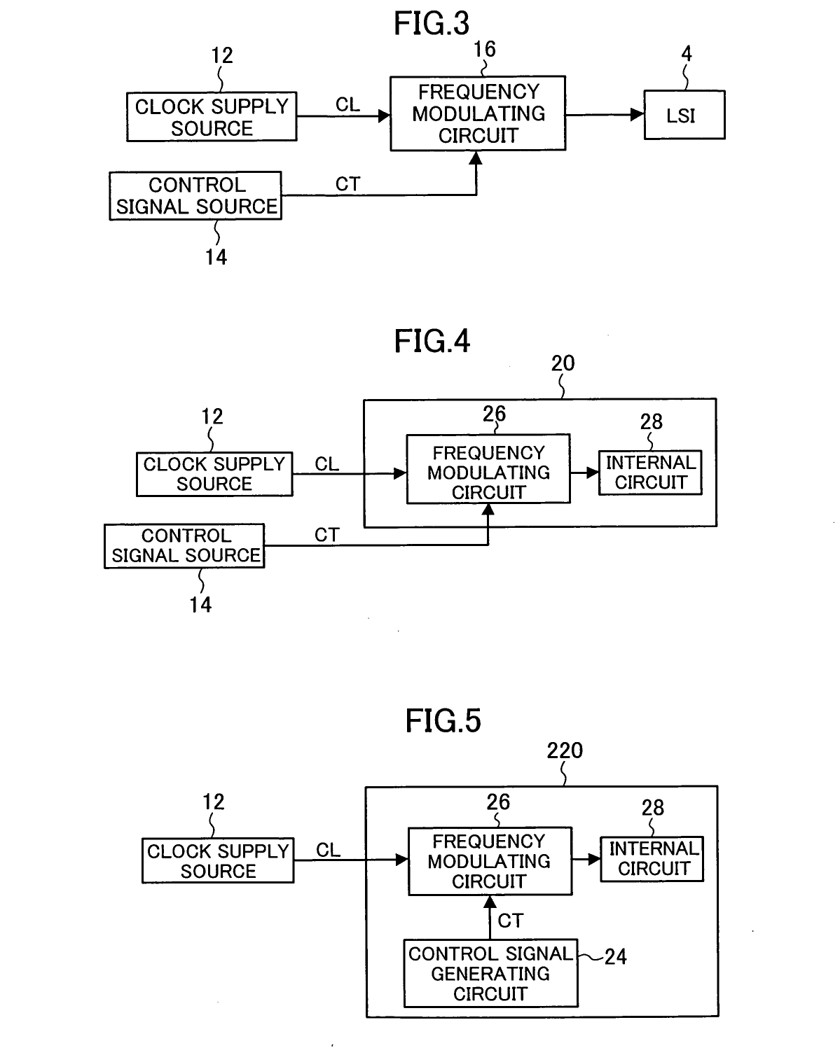

FIG. 3 is a block diagram illustrating a variation of the circuit of FIG. 1. The circuit of FIG. 3 comprises a clock supply source 12, a control signal source 14, a frequency modulating circuit 16, and an LSI 4. The frequency modulating circuit 16 and the LSI 4 are mounted on the same mount board.

The clock supply source 12 outputs a clock CL having a constant frequency to the frequency modulating circuit 16. The frequency modulating circuit 16 changes the frequency of the clock CL in accordance with a control signal CT output from the control signal source 14, and outputs the resultant clock to the LSI 4 to change the operating frequency of the LSI 4. The control signal source 14 outputs the control signal CT for controlling the frequency of the clock output by the frequency modulating circuit 16 and the timing of changing the frequency as illustrated in FIG. 2C. Thus, the clock supply source 12, the control signal source 14, and the frequency modulating circuit 16 of FIG. 3 collectively operate in a manner similar to that of the above-described clock supply source 2 of FIG. 1, and will not be described in detail.

In the circuit of FIG. 3, the frequency modulating circuit 16 and the LSI 4 are mounted on the same mount board, and therefore, even when the clock CL having the constant frequency is applied to the mount board, the frequency of the clock CL can be changed as illustrated in FIG. 2C.

FIG. 4 is a block diagram illustrating another variation of the circuit of FIG. 1. The circuit of FIG. 4 comprises a clock supply source 12, a control signal source 14, and an LSI 20. The LSI 20 has a frequency modulating circuit 26 and an internal circuit 28. The frequency modulating circuit 26 and the internal circuit 28 may be formed on the same semiconductor substrate.

The frequency modulating circuit 26 is a circuit which has a function similar to that of the frequency modulating circuit 16 of FIG. 3. The internal circuit 28 corresponds to the LSI 4 of FIG. 3. The frequency modulating circuit 26 changes the frequency of the clock CL in accordance with the control signal CT output from the control signal source 14 and outputs the resultant clock to the internal circuit 28 to change the operating frequency of the internal circuit 28.

FIG. 5 is a block diagram illustrating still another variation of the circuit of FIG. 1. The circuit of FIG. 5 comprises a clock supply source 12 and an LSI 220. The LSI 220 has a control signal generating circuit 24, a frequency modulating circuit 26, and an internal circuit 28. The control signal generating circuit 24, the frequency modulating circuit 26, and the internal circuit 28 may be formed on the same semiconductor substrate.

The control signal generating circuit 24 and the frequency modulating circuit 26 are circuits which have functions similar to those of the control signal source 14 and the frequency modulating circuit 16 of FIG. 3, respectively. The internal circuit 28 corresponds to the LSI 4 of FIG. 3. The control signal generating circuit 24 outputs a control signal CT for controlling the frequency of a clock output by the frequency modulating circuit 26 and the timing of changing the frequency as illustrated in FIG. 2C.

The circuits of FIGS. 4 and 5 are the same as that of FIG. 3, except that the frequency modulating circuit 26 and the control signal generating circuit 24 are included in the LSIs 20 and 220, respectively. Therefore, FIGS. 4 and 5 will not be described in detail.

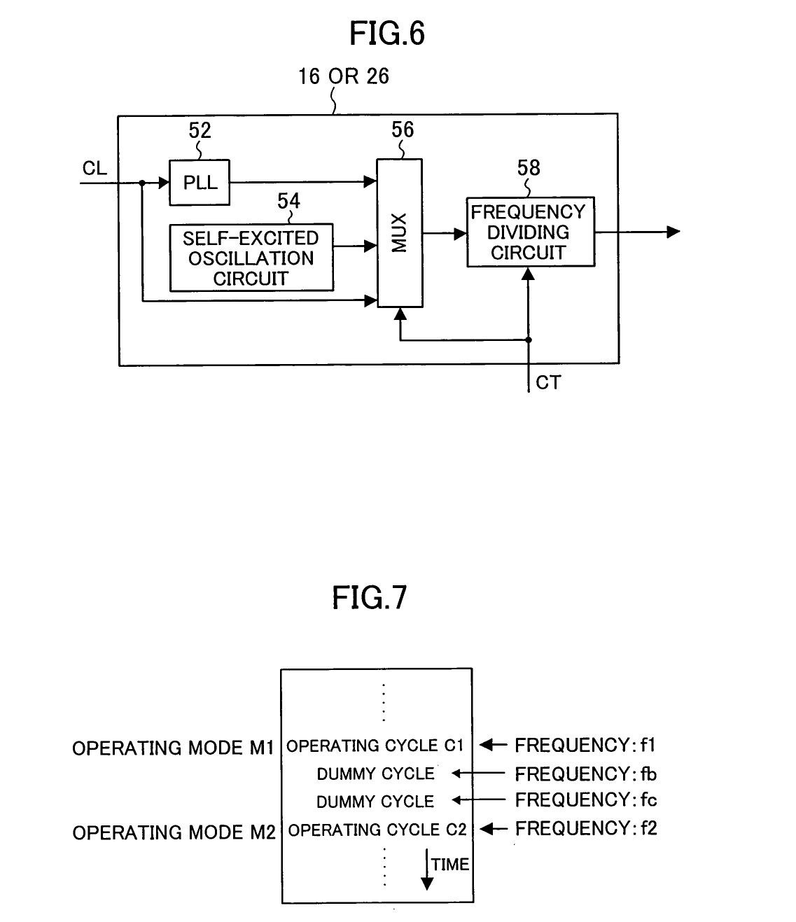

FIG. 6 is a block diagram illustrating an exemplary configuration of a frequency modulating circuit of FIGS. 3 to 5. The frequency modulating circuit of FIG. 6 comprises a phase locked loop circuit (hereinafter referred to as a PLL) 52, a self-excited oscillation circuit 54, a multiplexer (MUL) 56, and a frequency dividing circuit 58.

The PLL 52 outputs a signal which is in synchronization with the clock CL supplied from the clock supply source 12, to the multiplexer 56. The self-excited oscillation circuit 54 outputs a signal which is generated by oscillating irrespective of the clock CL, to the multiplexer 56. The multiplexer 56 selects one from the output of the PLL 52, the output of the self-excited oscillation circuit 54, and the clock CL in accordance with the control signal CT, and outputs the selected one to the frequency dividing circuit 58. The frequency dividing circuit 58 frequency-divides the output of the multiplexer 56 with a frequency division ratio designated by the control signal CT.

Note that the output of the PLL 52, the output of the self-excited oscillation circuit 54, and the clock CL may be input to the frequency dividing circuit 58 without using the multiplexer 56.

FIG. 7 is a diagram for explaining insertion of a dummy cycle during inspection. In the case of inspection of an LSI, when the frequency of a clock supplied to the LSI 4 or the internal circuit 28 is changed as illustrated in FIGS. 2A to 2C, the power supply voltage varies during the frequency modulation periods FM1 to FM4, so that there is a possibility that it cannot be correctly determined whether or not the LSI is a non-defective product (non-defective product/defective product determination), i.e., a non-defective product may be determined to be a defective product.

Therefore, the non-defective product/defective product determination is not performed during the frequency modulation periods FM1 to FM4. Specifically, dummy cycles in which the non-defective product/defective product determination is not performed are inserted during the frequency modulation periods FM1 to FM4.

For example, as illustrated in FIG. 7, in the operating mode M1 with the clock frequency f1, an operating cycle C1 during which the non-defective product/defective product determination is performed is executed. Thereafter, for a period of time during which the clock frequency is fb and a period of time during which the clock frequency is fc, a clock having a frequency other than the frequencies which are used in the operating modes is supplied to the LSI 4 and the internal circuit 28, so that a dummy cycle is executed. Thereafter, in the operating mode M2 with the clock frequency f2, an operating cycle C2 during which the non-defective product/defective product determination is performed is executed.

A point where a dummy cycle is inserted may be automatically detected from a change pattern of the clock frequency using software. A dummy cycle may be inserted manually, or automatically using software.

Thus, by inserting a dummy cycle, erroneous determination can be avoided, and the frequency modulation periods FM1 to FM4 can be arbitrarily set. Note that, if erroneous determination does not occur, a dummy cycle may not be inserted.

As described above, the present invention reduces spikes which occur in a power supply voltage when operating modes of an integrated circuit are changed, to stabilize a power supply voltage, and therefore, is useful for an integrated circuit and the like.

What is claimed is:

1. A method for controlling an operating frequency of an integrated circuit when operating modes with different operating frequencies are changed, comprising the step of:
changing the operating frequency of the integrated circuit to an operating frequency of an operating mode after changing, in a stepwise manner.

2. The method of claim 1, wherein, when an operating frequency at the time of start of an operation of the integrated circuit or in the operating mode after changing is higher than an operating frequency of an operating mode before changing, the operating frequency of the integrated circuit is increased in a stepwise manner.

3. The method of claim 1, wherein, when an operating frequency at the time of end of an operation of the integrated circuit or in the operating mode after changing is lower than an operating frequency of an operating mode before changing, the operating frequency of the integrated circuit is decreased in a stepwise manner.

4. The method of claim 1, wherein the operating frequency of the integrated circuit is changed by a clock supply source changing a frequency of a clock supplied to the integrated circuit.

5. The method of claim 1, wherein the operating frequency of the integrated circuit is changed by a frequency modulating circuit supplied with a clock from a clock supply source, changing a frequency of a clock supplied to the integrated circuit.

6. The method of claim 5, wherein the frequency modulating circuit is mounted on the same mount board as that on which the integrated circuit is provided.

7. The method of claim 1, wherein the integrated circuit comprises a frequency modulating circuit and an internal circuit, and
an operating frequency of the internal circuit is changed by the frequency modulating circuit supplied with a clock from a clock supply source, changing a frequency of a clock supplied to the integrated circuit.

8. The method of claim 7, wherein the integrated circuit further comprises a control signal generating circuit for controlling timing with which the frequency modulating circuit changes the frequency of the clock supplied to the internal circuit.

9. The method of claim 1, wherein the number of steps of the operating frequency and an operating frequency at each of the steps are set so that a variation in a power supply voltage supplied to the integrated circuit remains within a predetermined range.

10. The method of claim 1, wherein, when the integrated circuit is inspected, a non-defective product/defective product determination is not performed with respect to the integrated circuit before the operating frequency of the integrated circuit is changed to the operating frequency of the operating mode after changing.
